(19) United States
(12) Patent Application Publication
(10) Pub. No.: US 2014/0346797 A1
(43) Pub. Date: Nov. 27, 2014

(54) No Bull Horns

(71) Applicant: Carlos A. Rodriguez, McKinney, TX (US)

(72) Inventor: Carlos A. Rodriguez, McKinney, TX (US)

(21) Appl. No.: 13/898,586

(22) Filed: May 21, 2013

(51) Int. Cl. B60R 13/04

(52) U.S. Cl. CPC B60R 13/04
USPC 296/1.08

(57) ABSTRACT

The invention is of an anthropomorphic automobile accessory of a bovine species. The anthropomorphic accessory gives the automobile the look of a bull, a buffalo or any bovine species head. The anthropomorphic accessory comes as a set and it is a three-dimensional object. In addition, the anthropomorphic accessory has a custom cover that can be mounted over each of the accessories (horn). The anthropomorphic accessories are meant to advertise a high school, a college, a professional team, a town, a place, an event or a business.

### FIELD OF THE INVENTION

The following invention relates generally to automotive accessories and, more particularly, to accessories attached to an exterior part of an automobile or any vehicle in general.

### BACKGROUND

Automobiles have been customized and decorated in a variety of ways for many years. These decorations can include attachments, electronics or modifications to the original product. Some automobile owners customize their vehicle based on their heritage, sports team, club affiliation, an event or a business. For many people, in many instances, their automobiles can be also an extension of themselves in more than one way. One of the many purposes of customizing vehicles is to allow individuals to express their personality through their automobiles. In this particular case the use of a “real lookalike” horn

### SUMMARY

An anthropomorphic vehicle accessory is disclosed, which can be attached to an exterior of a vehicle to personify an animal characteristic to the vehicle.

In one aspect, an anthropomorphic vehicle kit is disclosed. The anthropomorphic vehicle kit includes an interface portion shaped as an inversed U to attach the accessory to a vehicle, and two objects resembling bovine horns. The anthropomorphic vehicle kit can also include instructions for coupling the accessory to the vehicle, as well as customized covers representing a school, sports team, club affiliation, an event, business, a city or a place.
There has thus been outlined, rather broadly, the more important features for the anthropomorphic vehicle accessory or invention so that the detailed description that follows may be better understood. There are also detailed drawings included that will help the better understanding of this invention. Other features of the present invention will become clearer from the following detailed description of the invention, taken with the accompanying drawings and claims.

### BRIEF SUMMARY OF THE INVENTION

The following is intended to be a brief summary of the invention and it is not intended to limit the scope of the invention.

The anthropomorphic vehicle accessory is a replica of a bovine horn from an actual Longhorn bull, mounted on a plastic support.

The process to create the horn is cast molding. The anthropomorphic vehicle accessory is intended to provide a quick way of adding a bull like of bovine animal look to a vehicle. (See FIG. 6)

The material used to create the anthropomorphic vehicle accessory is expandable foam.

The anthropomorphic vehicle accessory is given a two-tone color with a random pattern created for each horn making it look as real as possible to an authentic bovine head. (See FIG. 9)

The support for the anthropomorphic vehicle accessory is made out of flexible plastic and it penetrates the foam in a 30 degrees angle. (See FIG. 1, FIG. 2, FIG. 3 and, FIG. 4)

The plastic support pole has a flat base. A 1 inch pole extends out in the middle and two rings at end of it. (See FIG. 4)

### BRIEF DESCRIPTION OF THE DRAWING

In order to understand the application, functionality and description of the anthropomorphic vehicle accessory some images have been included

FIG. 1 shows an example of the physical structure (Right hand part): schematic, diagram and actual elements of the anthropomorphic vehicle accessory

FIG. 2 shows a side view of the anthropomorphic vehicle (Right hand part) accessory and the support system

FIG. 3 shows the anthropomorphic vehicle (Right hand part) accessory and support from a back angle

FIG. 4 shows the dimensions and specifications of the support pole (Part B) used to hold the anthropomorphic vehicle accessory in place on a car window.

FIG. 5 shows steps by step how the anthropomorphic vehicle accessory is placed on a window of a car

FIG. 6 shows an illustration of the full set of anthropomorphic vehicle accessory as is used on two separate vehicles.

FIG. 7 is an illustration of the anthropomorphic vehicle accessory with examples of covers from a college and a professional team mounted on two types of vehicles.

FIG. 8 is an illustration of three anthropomorphic vehicle accessories with different cover themes (FC, Dallas, UT Longhorns, Fort Worth Stockyards)

FIG. 9 shows the set anthropomorphic vehicle accessory without covers. It also shows the randomize pattern each of the accessory has.

### DETAILED DESCRIPTION

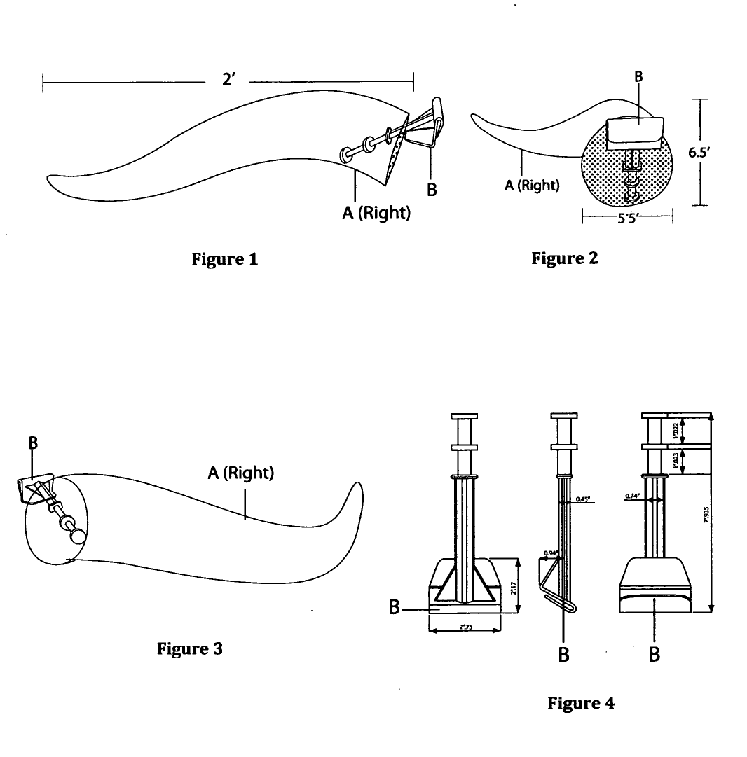

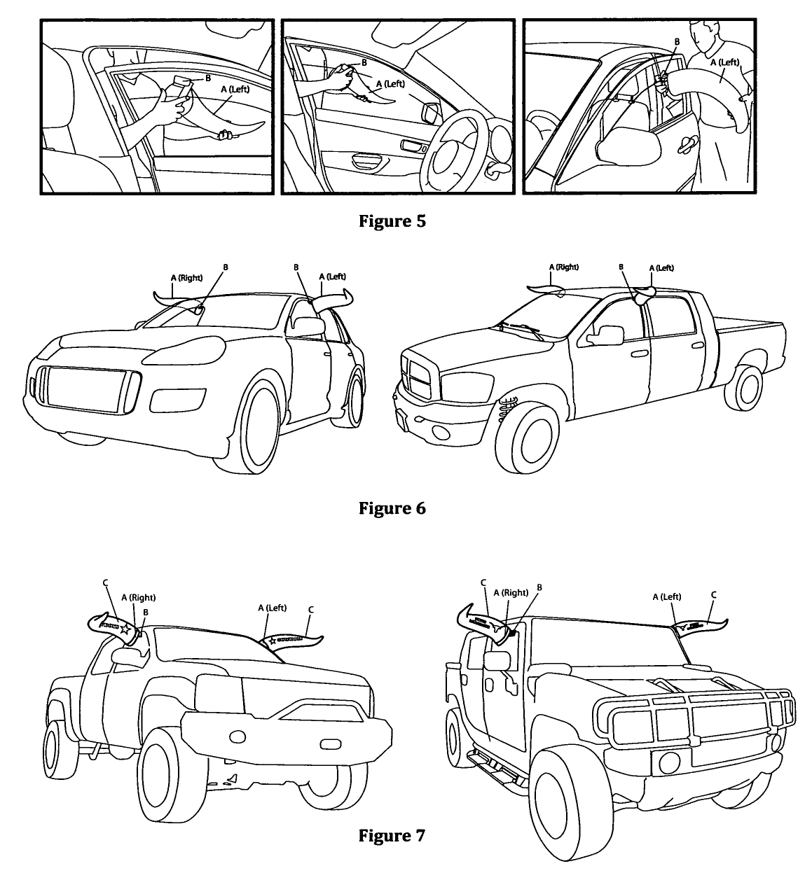

This invention is not limited to a particular process and/or materials disclosed herein as such may vary to some degree. Furthermore, it is to be understood that the terminology used here is used for the purpose of describing particular embodiments only and is not intended to be limiting, as the scope of the present invention will be defined only by the appended claims and equivalents thereof. FIG. 1 shows a front view of the anthropomorphic vehicle kit. The base (B) of the accessory (A) has a plastic support (See FIG. 4) that is what holds the accessory (A) in place once an anthropomorphic accessory has been placed and the window has been rolled up.

With reference to FIG. 1, illustrated is an anthropomorphic vehicle accessory (A) attached to a vehicle. The anthropomorphic vehicle accessory (A) can impart a bovine animal form, characteristic, or attribute to the vehicle. In other words, the anthropomorphic vehicle accessory (A) can personify the vehicle, or represent the vehicle in the form of a bovine animal. The anthropomorphic vehicle accessory (A) can be used by a vehicle's owner or its operator to transform a vehicle into something that resembles an animal. In one aspect, the anthropomorphic vehicle accessory (A) can reflect the personality of the vehicle's owner. For example, the anthropomorphic vehicle accessory can reflect the owner's own heritage or background, sports team preference, tourist destination, an event, a business, etc.

The decoration would vary according by the use of a cover (C). The anthropomorphic vehicle accessory (A) would easily attach to the vehicle's driver and passenger side windows to display a symmetrical appearance to onlookers, transforming the automobile into a bull like or bovine figure. (See FIG. 6 and FIG. 7)

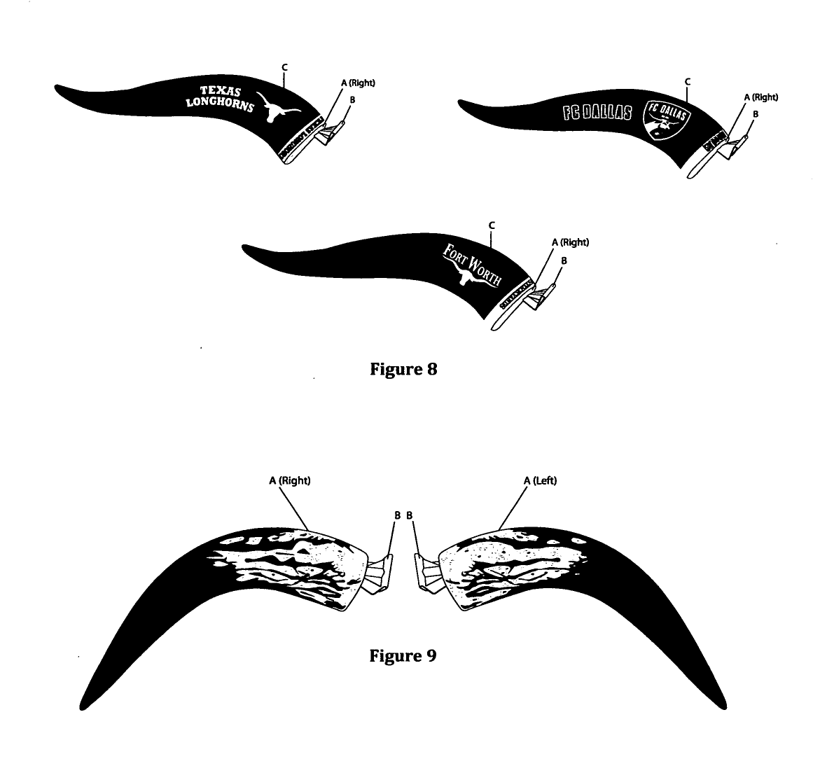

The present invention includes a car decoration similar to the college flags that are attached to car windows on the way to a ball game, but instead of a flag there is a anthropomorphic vehicle accessory (A) with a cover (C) reflecting the team emblem such as Texas Longhorns, Dallas Cowboys, Houston Texans, FC Dallas Soccer Club or, a Particular City or event. (See FIG. 7 and FIG. 8

The anthropomorphic vehicle accessory (A) can be attached to a surface of the vehicle by a base (B) such that the accessory is visible on an exterior of the vehicle. Placement of the horns proximate to the front side windows takes advantage of existing windows of a vehicle to form the side upper part of the head or temples of the vehicle. Thus, disposing the horns above the “temples” of the vehicle are suitable locations for anthropomorphic vehicle accessories resembling a bovine head with horns.

The detailed description and accompanying drawings are to be regarded as merely illustrative and not as restrictive, and all such modifications or changes, if any, are intended to fall within the scope of the present invention as described and set forth herein.

It should be noted that an anthropomorphic vehicle accessory or components thereof can be disposed on any suitable vehicle surface and is not to be limited by the examples discussed herein. For instance, a suitable vehicle surface can include at least one of a backside window, a hood, a bumper, a door, or combinations thereof. Furthermore, a typical vehicle can be an automobile, although other vehicles such as, but not limited to, boats, golf-carts, all-terrain vehicles, motorcycles, mopeds, and the like can also be suitable subjects of the vehicle accessories and systems described herein.

1. Apparatus for decorating vehicles, comprising: an anthropomorphic vehicle accessory with a base for attaching to a window of a vehicle, the anthropomorphic accessory including an upside-down U-shaped bracket on its base that tapers to form a clamp on the vehicle window, wherein the bracket is shaped to slip down over a partially opened vehicle window and to secure the anthropomorphic accessory to the vehicle when the window is rolled up, and wherein the base of the upside-down U-shaped bracket protrudes out from vehicle window when the window is rolled up; from the base, the anthropomorphic vehicle accessory rises upwards and forms a three-dimensional bovine like horn.

2. The anthropomorphic vehicle accessory of claim 1, wherein the decoration is one from the group consisting of a bovine-like horn.

3. The anthropomorphic accessory of claim 1, wherein the decoration customized covers represents a school, sports team, club affiliation, an event, business, a city or a place.

4. The anthropomorphic vehicle accessory of claim 1, wherein the decoration is made of expandable foam (Polyurethane Foam) with a plastic U-shaped base attached at the bottom for support.

5. The anthropomorphic vehicle accessory of claim 1, wherein the decoration's cover is made out of expandable fabric also known as spandex or lycra.

6. The anthropomorphic vehicle accessory of claim 1, wherein the measured distance from the bracket to the end of the decoration is about 2′-2′0.5″.

7. The anthropomorphic vehicle accessory of claim 1, wherein the measured distance from the width of the base of the decoration is about 5″-5.5″.

8. The anthropomorphic vehicle accessory of claim 1, wherein the measured distance from the bottom of the decoration to the top of the decoration is about 6″-6.5″.

9. A method of decorating a vehicle, comprising attaching two of the anthropomorphic vehicle accessories of claim 1 to the right and left side of a vehicle's side windows.
